(19) United States
(12) Patent Application Publication
(10) Pub. No.: US 2026/0097802 A1
(43) Pub. Date: Apr. 9, 2026

(54) STEER-BY-WIRE STEERING SYSTEM

(71) Applicant: Robert Bosch GmbH, Stuttgart (DE)

(72) Inventor: Senthilkumar Thulasidass, Schwaebisch Gmuend (DE)

(21) Appl. No.: 19/349,583

(22) Filed: Oct. 3, 2025

(30) Foreign Application Priority Data
Oct. 8, 2024 (DE) 10 2024 209 782.9

(51) Int. Cl. B62D 5/00; B62D 5/04

(52) U.S. Cl. CPC B62D 5/006; B62D 5/0409; B62D 5/0421; B62D 5/046

(57) ABSTRACT

A steer-by-wire steering system for a vehicle includes a steering wheel actuator and a rack actuator. The steering wheel actuator includes a first motor which is to be controlled via a first output stage. The rack actuator includes a second motor which is to be controlled via a second output stage. A signal and current interface is provided between the steering wheel actuator and the rack actuator that is set up such that the first output stage of the steering wheel actuator is to be controlled via the interface in order to cause passive braking of the first motor.

This application claims priority under 35 U.S.C. § 119 to application no. DE 10 2024 209 782.9, filed on Oct. 8, 2024 in Germany, the disclosure of which is incorporated herein by reference in its entirety

The disclosure relates to a steer-by-wire steering system for a vehicle, in particular a motor vehicle, and a method for passively braking a motor of a steering wheel actuator in such a steer-by-wire steering system.

### BACKGROUND

A steer-by-wire steering system provides that a steering command is only electrically transmitted from a sensor to an electromechanical actuator that executes the steering command, via one or more control devices. Such a steering system regularly comprises a feedback unit, e.g. a steering wheel actuator, a steering actuator, for example in the form of a steering rack actuator, and a unit for evaluating and calculating signals that are implemented, for example, in software or in software functions.

The steering wheel actuator is configured to perform two main functions. One task is to transmit the user's command to the rack actuator. Furthermore, the steering wheel actuator provides a stiffness or strength and feedback for the user.

In the event of a fault during the journey, the strength or stiffness of the control or steering is lost. This may cause the driver to oversteer, which may result in loss of control of the vehicle and even an accident.

Currently, the system uses a two-channel system having a six-phase motor and two independent power supplies to limit or mitigate the above-mentioned error. This makes the system very expensive. In addition, it is not possible to respond appropriately to a fault or failure in the power supply in both channels.

### SUMMARY

Against this background, a steer-by-wire steering system and an associated method are presented. Embodiments arise from the description.

The steer-by-wire steering system presented is intended for use in a vehicle, in particular a motor vehicle. This steering system comprises a steering wheel actuator and a rack actuator, wherein the steering wheel actuator comprises a first, in particular electric, motor which is to be controlled via a first output stage, and the rack actuator comprising a second in particular electric motor which is to be controlled via a second output stage.

Communication between the steering wheel actuator and the rack actuator is already available in steer-by-wire steering systems to exchange data, for example, regarding an angle request, a steering feedback, and the state of both systems. In addition to this communication link or communication interface, an additional signal and current interface or connection between the steering wheel actuator and the rack actuator is provided.

The function of this additional signal and current interface is to:
1. control the first power stage of the steering wheel actuator to passively brake the motor.
2. provide power to the rotor position sensor (RPS).
3. pass on the steering angle input request sensed by the RPS to the rack actuator.

The first output stage may include a bridge circuit with high side switches and low side switches, wherein the low side switches are to be controlled in order to cause passive braking.

To reduce the number of lines or cables between the steering wheel actuator and the rack actuator, the control terminals or gate of the three low side switches may be combined via an OR gate and controlled by a single signal.

An error in the steering wheel actuator is indicated by the communication link, which triggers the rack actuator to enable or activate the signal in order to control the power stages of the steering wheel actuator to perform passive braking.

This avoids the need for an additional channel on a six-phase motor for the steering wheel actuator.

Furthermore, a method for passively braking a motor of a steering wheel actuator in a steer-by-wire steering system of the type described above, in which the first motor, i.e., the motor of the steering wheel actuator, is to be controlled via the first output stage is presented. In the method, if necessary, for example in the event of a fault in the steering wheel actuator, this is sensed by the steering wheel actuator via a communication link and a control signal is provided to the rack actuator of the output stage of the motor, which causes passive braking of the motor.

A control unit of the rack actuator also provides power to the RPS. The RPS of the rack actuator returns the steering angle input requested by the driver to the rack actuator to control the vehicle.

Passive braking is understood to mean braking that is not directly triggered by the driver. In contrast, active braking is performed by the driver, for example by actuating a brake pedal. In this case, passive braking, also referred to as passive damping, causes a braking function on the motor of the steering wheel actuator, such that this increases the stiffness or strength of steering. The driver receives this by providing feedback via the steering wheel. In this way, oversteering by the driver may be avoided.

In the method presented and the steering system in which the method is implemented, a passive damping method is used that does not require a redundant channel, a six-phase motor, or an additional power supply. The safety of the steering system can be ensured with a three-phase motor, a driver via a single channel and a single power supply. As such, a private controller area network (CAN) available between the rack actuator and the steering wheel actuator monitors the state of the rack actuator.

A possible embodiment is discussed below:

In the event of loss of communication, the microcontroller in the rack actuator decides to activate passive damping in the steering wheel actuator. This is achieved by a particular signal connection between the rack actuator and the steering angle actuator. The signal connector has four or five pins for a current controlled output (CCO) for a 12 V driver supply, for ground, for RPS COS and SIN signals of the SWA, and optionally for a PWM signal (PWM: pulse width modulation) to vary the strength of passive braking.

In the event of a fault or failure in the steering wheel actuator, the rack actuator activates the CCO driver within the error tolerance time. The three low side FETs of the rack actuator are turned on via an OR gate that realized with diodes, for example, to provide passive braking. The driver may still control the vehicle because the driver's steering input is sensed by the RPS and sent to the rack actuator. Passive braking provides the required steering stiffness for the driver.

An additional PWM signal may be added to control passive damping to vary stiffness as a function of the speed of the vehicle. The passive damping method may also be used in a six-phase system with a single battery to increase system safety at a lower cost.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows an embodiment of the presented steer-by-wire steering system in a block diagram.

FIG. 2 shows a flow chart of a possible sequence of the presented method.

FIG. 3 shows, in a purely schematic, highly simplified illustration, a vehicle having a steer-by-wire steering system of the type described herein.

### DETAILED DESCRIPTION

The disclosure is illustrated schematically by way of embodiments in the drawings and is described in detail below with reference to the drawings.

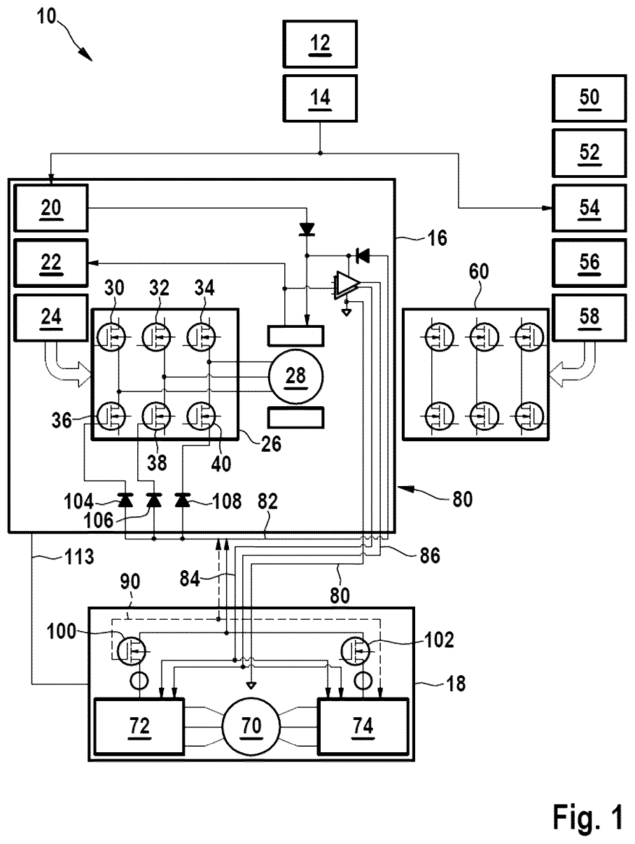

FIG. 1 shows, in a block diagram, a steer-by-wire steering system, which is designated with reference numeral 10 in total. The illustration shows a battery connector 12, a battery filter 14, a steering wheel actuator 16, and a rack actuator 18.

The steering wheel actuator 16, shown on the left, includes a system base chip 20, a microcontroller 22, a gate driver unit 24, an output stage 26, and a three-phase motor 28. Six semiconductor switches, for example, MOSFETs or IGBTs, are provided in the output stage 26, namely three high side switches 30, 32, 34 and three low side switches 36, 38, 40. The output stage 26 is thus provided by a bridge circuit.

Optional components are shown on the right side of the illustration, namely, an optional battery connector 50, an optional battery filter 52, an optional system base chip 54, an optional microcontroller 56, an optional gate driver unit 58, and an optional output stage 60, which in turn has six semiconductor switches in a bridge circuit. These optional components represent a further channel so that a six-phase motor can also be controlled. However, this further channel is not required here to be able to perform passive braking of the motor 28.

The rack actuator 18 includes a six-phase motor 70, a channel A 72, and a channel B 74. In these channels 72, 74, the components for controlling the six-phase motor 70, such as output stages, driver units, microcontrollers, system base chip, battery connectors, battery filters, etc., are provided.

A signal and current interface 80 is now provided between steering wheel actuator 16 and rack actuator 18, which in this case comprises five signal lines. These signal lines are used to transmit the following signals:

| | |
|---|---|
| a limited power supply for passive damping | 82, |
| cosine rotor position sensor | 84, |
| sine rotor position sensor | 86, |
| Ground | 88 |
| PWM signal | 90. |

There is CAN (Controller Area Network) communication between the steering wheel actuator 16 and rack actuator 18 in the steer-by-wire steering system 10 via a CAN communication interface 113.

A signal to drive the 12V passive damping supply is currently limited to avoid an external short circuit with the housing.

It should be noted that a switch 100 or 102 is assigned to each channel 72, 74 in the rack actuator 18 via the signal line 90 for the limited power supply, via which a power supply for the low side switches 36, 38, 40 in the output stage 26 of the steering wheel actuator 16 can be controlled. Furthermore, three diodes D1 104, D2 106 and D3 108 are provided in the signal line 90 that realize an OR function. The function of the three diodes 104, 106, 108 is to control the three low side switches 26, 38, 40 with one signal.

Passive damping thus allows a redundant channel, a second battery connector and battery filter to be omitted. For this purpose, only a connector for a four or five-pole signal between the rack actuator (SRA) and the steering wheel actuator is to be added. In this way, the control function is retained even if supply by the battery to the steering wheel actuator is no longer available. The degree or levels of damping and/or steering stiffness may be controlled by the use of an additional PWM signal.

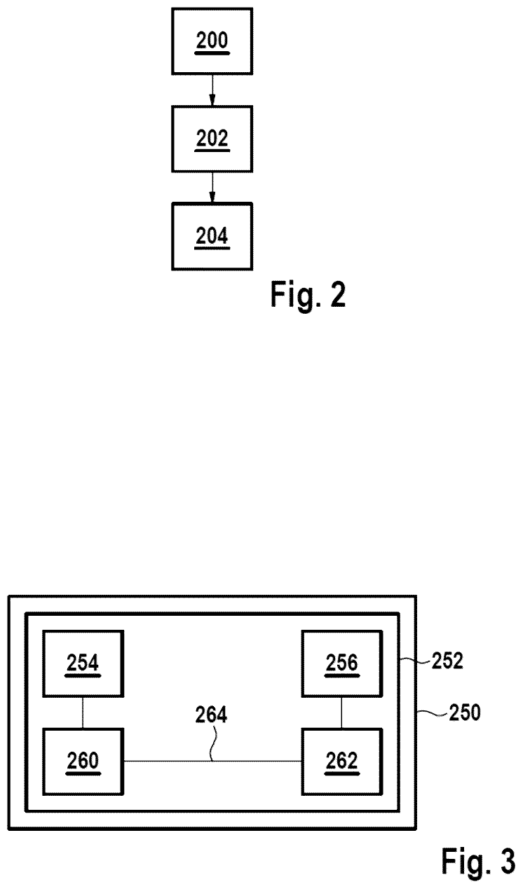

FIG. 2 shows a flow chart of a possible embodiment of the described method. In a first step 200, operation of a vehicle and its steer-by-wire steering system begins. In a next step 202, a state is sensed in which there is a threat of oversteering by the driver. Passive braking of the motor of the steering wheel actuator of the steer-by-wire steering system is then effected in a step 204, so that the risk of oversteering is averted. The driver's steering angle input is directed to the rack actuator via RPS to control the vehicle

FIG. 3 shows a highly simplified representation of a vehicle, purely in schematic form, which is labeled with the reference number 250. This vehicle 250 has a steer-by-wire steering system 252 in which a steering wheel 254 and a rack 256 are provided. The steering wheel 254 is associated with a steering wheel actuator 260 and the rack 256 is associated with a rack actuator 262. A signal and power interface 264 is provided between the steering wheel actuator 260 and the rack actuator 262.

What is claimed is:

1. A steer-by-wire steering system for a vehicle, comprising:
a steering wheel actuator that includes a first motor configured to be controlled via a first output stage;
a rack actuator that includes a second motor configured to be controlled via a second output stage; and
a signal and current interface provided between the steering wheel actuator and the rack actuator,
wherein the signal and current interface is configured such that the first power stage of the steering wheel actuator is to be controlled via the signal and current interface to cause passive braking of the first motor.

2. The steer-by-wire steering system according to claim 1, wherein an OR gate is provided in a communication link.

3. The steer-by-wire steering system according to claim 2, wherein the OR gate is implemented by diodes.

4. The steer-by-wire steering system according to claim 1, wherein a bridge circuit with high side switches and low side switches is provided in the first output stage, and wherein the low side switches are configured to be controlled to cause passive braking.

5. The steer-by-wire steering system according to claim 1, wherein at least one switch is provided in the signal and current interface to trigger the control of the first output stage for passive braking of the first motor.

6. The steer-by-wire steering system according to claim 1, wherein another channel is associated with the steering wheel actuator.

7. The steer-by-wire steering system according to claim 2, wherein the communication link comprises signal lines for the following signals:
a limited power supply for passive damping,
a cosine rotor position sensor,
a sine rotor position sensor, and
ground.

8. The steer-by-wire steering system according to claim 7, wherein the signal and current interface comprises a signal line for an additional PWM signal.

9. A method for passively braking a first motor of a steering wheel actuator in the steer-by-wire steering system according to claim 1, wherein the first motor is configured to be controlled via the first output stage, the method comprising:
providing a signal via the signal and current interface between the steering wheel actuator and the rack actuator of the first output stage of the first motor so as to cause passive braking of the first motor.

10. The method according to claim 9, wherein the first output stage comprises a bridge circuit of switches which include high side switches and low side switches, and wherein the low side switches of the first output stage are controlled for passive braking of the first motor.
